(19) United States
(12) Patent Application Publication
(10) Pub. No.: US 2009/0181844 A1
(43) Pub. Date: Jul. 16, 2009

(54) Ceramic Material

(75) Inventor: Masakazu Hashimoto, Shizuoka (JP)

Correspondence Address: DAY PITNEY LLP, 7 TIMES SQUARE, NEW YORK, NY, 10036-7311, US

(73) Assignee: CO-EI CO., LTD., Shizuoka-shi, Shizuoka (JP)

(21) Appl. No.: 11/579,187

(22) PCT Filed: Dec. 22, 2005
(86) PCT No.: PCT/JP2005/023686

§ 371 Date: Oct. 31, 2006

(51) Int. Cl. C04B 35/14

(52) U.S. Cl. 501/135; 501/153

(57) ABSTRACT

Conventionally, in order to improve health problems, there have been technologies using ceramic materials, which are considered to have effects of far-infrared radiation, for accessories and films etc. These accessories and films etc. have effects of improving blood circulation or metabolism by far-infrared radiation etc. However, in the conventional technologies, the far-infrared radiation is insufficient, so that health problems cannot be sufficiently improved.

The present invention provides a ceramic material, containing silicon, aluminum, iron, calcium, titanium, and potassium as major constituents; and sulfur, strontium, vanadium, and yttrium as accessory constituents. In addition, the ceramic material of the present invention may be used for products such as cloth, accessories, filters for liquid, and cosmetic products.

### BACKGROUND OF THE INVENTION

1. Field of the Invention

The present invention relates to a ceramic material having various biological-functions such as an effect of far-infrared radiation,

2. Description of the Related Art

Recently, changes in social and living environments cause various human health problems. For example, such as water pollution, environmental hormones, food additives and electromagnetic waves or health problems caused by living environmental changes or changes of living styles such as stress, lack of exercise and unbalanced diet. With these factors, the blood and cells in a body are oxidized. This causes decline in the blood circulation and causes lack of oxygen supply and nutrition to the living cells. This also causes decline in immune-enhancing power and result in decrease of cell division which result in shortening of life span of cells.

Conventionally, in order to overcome health problems, there have been technologies using ceramic materials, which are considered to have an effect of far-infrared radiation, for accessories and films etc. These accessories and films etc. have effects of improving blood circulation and metabolic functions through far-infrared radiation etc. (Japanese Patent Publication No. H7-88200) However, in the conventional technologies, the far-infrared radiation is insufficient, so that health problems cannot be sufficiently improved.

In order to solve the above deficiency, the applicant has invented a metal-ceramic composite material, the plastic-ceramic composite material, a ceramic material sprayed non-woven material, and a film-ceramic composite material, in which the ceramic materials have improved far-infrared radiation rate and contain tourmaline and graphite silica having reduction properties. (Japanese Patent Publication No. 2003-252685). These ceramic materials has effects of improving blood circulation through far-infrared radiation and properties of scavenging free-radicals through reduction.

However, the conventional ceramic material did not exhibit the desired effects such as infrared radiation effect. Further, the ceramic material of the above citation (Japanese Patent Publication No. 2003-252685) cannot exhibit the infrared radiation effect, free-radical scavenging effect, and effect of reducing hydraulic conductivity just by containing the tourmaline and graphite silica.

### SUMMARY OF THE INVENTION

In order to solve the above deficiency, the applicant has found a novel material and composition having an infrared radiation effect, free-radical scavenging effect, and effect of reducing hydraulic conductivity, so that successfully developed the ceramic material having the desired effect. The present invention on the basis of the above study results provides a ceramic material, a ceramic powder, and the products using the ceramic material and the ceramic powder, which are based on the novel material and composition.

The first invention is a ceramic material, containing four crystals respectively indicated by SiO₂, Na₆Al₆Si₁₀O₃₂.12H₂O, KCa(Si₅Al₃)O₁₆.6H₂O, and KAl₂Si₃AlO₁₀(OH)₂. The second invention is the ceramic material according to the first invention, further containing tourmaline. The third invention is the ceramic material according to the second invention, wherein the tourmaline is indicated by CaFe₃Al₆(BO₃)₃Si₆O₁₈(OH)₄.

The fourth invention is a ceramic material, containing silicon, aluminum, iron, calcium, titanium, and potassium as major constituents. The fifth invention is the ceramic material according to the fourth invention, further containing sulfur, strontium, vanadium, and yttrium as accessory constituents. The sixth invention is the ceramic material according to the fifth invention, containing 40 to 50 wt % silicon; 25 to 35 wt % aluminum; 5 to 15 wt % iron; 5 to 10 wt % calcium; 1 to 5 wt % titanium and potassium; and 0.01 to 1 wt % sulfur, strontium, vanadium, and yttrium. The seventh invention is the ceramic material according to any one of the fourth to sixth inventions, containing at least more than one of boron, lithium, carbon, oxygen, or nitrogen. The eighth invention is the ceramic material according to any one of the fourth to sixth inventions, containing 1 to 4% boron, 1 to 2% lithium, 0.1 to 4% carbon, 2 to 5% oxygen, and 0.1 to 4% nitrogen.

The ninth invention is the ceramic powder containing more than 90 wt % ceramic granules, wherein the ceramic material according to any one of the first to eighth inventions is made into a ceramic granule having a diameter of 1 to 5 μm. The tenth invention is a ceramic powder containing more than 90 wt % ceramic granules, wherein the ceramic material according to any one of the first to eighth inventions is made into the ceramic granule having a diameter of 10 to 100 nm. The eleventh invention is a cloth, wherein the ceramic material according to any one of the first to eighth inventions is used as a raw material. The twelfth invention is an accessory, wherein the ceramic material according to any one of the first to eighth inventions is used as a raw material. The thirteenth invention is a cosmetic product, wherein the ceramic powder according to the tenth invention is used. The fourteenth invention is a filter for liquid, wherein the ceramic powder according to the ninth or tenth invention is used.

A ceramic material of the present invention and products using the ceramic material have the following properties effective in overcoming health problems.

The first aspect of the present invention is infrared radiation properties. The infrared radiation rate of the ceramic material of the present invention is more than 80%, so that it becomes possible to improve blood circulation and metabolic functions.

The second aspect of the present invention is free-radical scavenging. Among free-radicals, hydroxy radical and superoxide anion radicals are metabolic by-products of living organisms and major causes of various diseases such as tumors or senescence. It is clarified that the ceramic material of the present invention has properties of free-radical scavenging, so that it becomes possible to prevent the various diseases such as tumors or to reduce senescence.

The third aspect of the present invention is reduction of hydraulic conductivity. Ions contained in water have an adverse effect on a living organism. By water decontamination using the ceramic material of the present invention, it becomes possible to obtain clean water and to improve health.

Embodiments of the present invention will be described hereinafter. The present invention is not to be limited to the above embodiments and able to be embodied in various forms without departing from the scope thereof.

Claims 1, 2, 3, 4, 5, 6, 7, and 8 will be described in the first embodiment. Claims 9 and 10 will be described in the second embodiment. Claims 11, 12, 13, and 14 will be described in the third embodiment.

### BRIEF DESCRIPTION OF THE DRAWINGS

FIG. 1 shows a result of X-ray fluorescence spectrometry on the ceramic material of the first embodiment;

FIG. 2 shows a result of analysis of elemental content;

FIG. 3 is a graph showing properties of scavenging hydroxy radical;

FIG. 4 is a graph showing properties of scavenging superoxide anion radical;

FIG. 5 shows alteration of hydraulic conductivity of tap water by the ceramic material;

FIG. 6 shows alteration of hydraulic conductivity of tap water by the ceramic material, heat-treated at various temperatures;

FIG. 7 shows blood rheological effects of the product of the third embodiment on a group of middle-aged men;

FIG. 8 shows blood rheological effects of the product of the third embodiment on a group of middle-aged women;

FIG. 9 shows blood rheological effects of the product of the third embodiment on a group of young men;

FIG. 10 shows blood rheological effects of the product of the third embodiment on a group of young women;

FIG. 11 shows blood rheological effects on a group of people wearing bracelets made of the product of the third embodiment;

FIG. 12 shows blood rheological effects on a group of people wearing necklaces made of the product of the third embodiment;

FIG. 13 shows blood rheological effects on a group of people wearing rings made of the product of the third embodiment;

FIG. 14 shows blood rheological effects on a group of people wearing watches made of the product of the third embodiment;

FIG. 15 shows blood rheological effects on a group of people using bedpads made of the product of the third embodiment;

FIG. 16 shows blood biochemical effects of the product of the third embodiment on a group of middle-aged men by;

FIG. 17 shows blood biochemical effects of the product of the third embodiment on a group of middle-aged women;

FIG. 18 shows blood biochemical effects of the product of the third embodiment on a group of young men;

FIG. 19 shows blood biochemical effects of the product of the third embodiment on a group of young women;

FIG. 20 shows blood biochemical effects on a group of people wearing bracelets made of the product of the third embodiment;

FIG. 21 shows blood biochemical effects on a group of people wearing necklace made of the product of the third embodiment;

FIG. 22 shows blood biochemical effects on a group of people wearing rings made of the product of the third embodiment;

FIG. 23 shows blood biochemical effects on a group of people wearing watches made of the product of the third embodiment;

FIG. 24 shows blood biochemical effects on a group of people using bedpads made of the product of the third embodiment;

FIG. 25 shows X-ray diffraction data of the ceramic material of the first embodiment;

FIG. 26 shows X-ray diffraction data of the ceramic material of the first embodiment.

### DETAILED DESCRIPTION OF THE PREFERRED EMBODIMENTS

The ceramic material of the present invention relates to substances as materials of products having properties of infrared radiation, of free-radical scavenging, and of reducing hydraulic conductivity.

The ceramic material of the first embodiment contains four crystals respectively indicated by SiO₂, Na₆Al₆Si₁₀O₃₂.12H₂O, KCa(Si₅Al₃)O₁₆.6H₂O, and KAl₂Si₃AlO₁₀(OH)₂.

SiO₂, Na₆Al₆Si₁₀O₃₂.12H₂O, KCa(Si₅Al₃)O₁₆.6H₂O, and KAl₂Si₃AlO10(OH)₂ respectively named as quartz, zeolite, philipsite, muscovite. The crystals thereof may be monocrystalline or polycrystalline.

It is preferable that the ceramic material of the first embodiment may further contain tourmaline. The tourmaline is generally indicated by WX₃B₃Al₃(AlSi₂O₉)₃(O,OH,F)₄(W═Na or Ca, X═Al, Fe³⁺, Li, Mg, or Mn²⁺). For example, the tourmaline can be indicated by CaFe₃Al₆(BO₃)₃Si₆O₁₈(OH)₄.

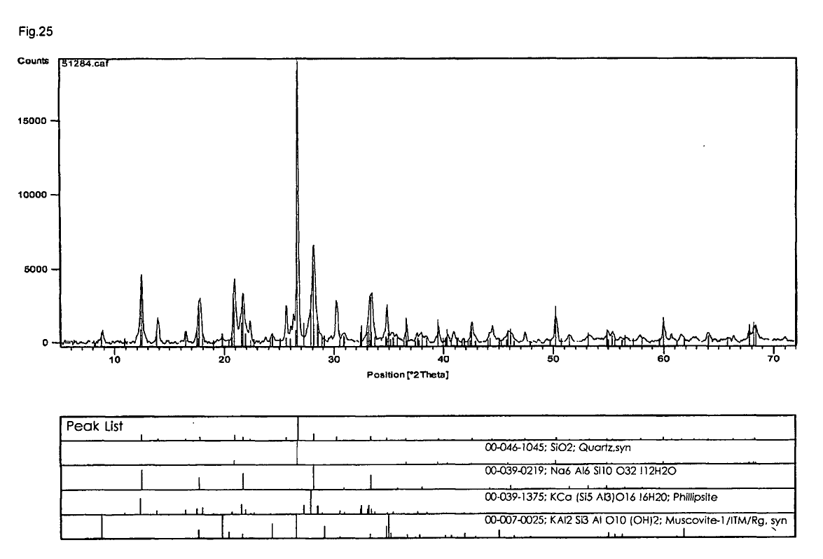

FIG. 25 shows X-ray diffraction data of the ceramic material of the first embodiment. The ceramic material was ground in a mortar before measuring, compressed and filled into a sample holder, and used for X-ray diffraction analysis. Crystals contained in the ceramic material is identified by matching the obtained X-ray diffraction data with ICCD card. Consequently, the four crystals, SiO₂, Na₆Al₆Si₁₀O₃₂.12H₂O, KCa(Si₅Al₃)O₁₆.6H₂O, and KAl₂Si₃AlO₁₀(OH)₂ were identified. Further, viewing from the intensity of the X-ray diffraction data, it is inferable that the orders of the contained amount of these crystals are the same as the above-mentioned order.

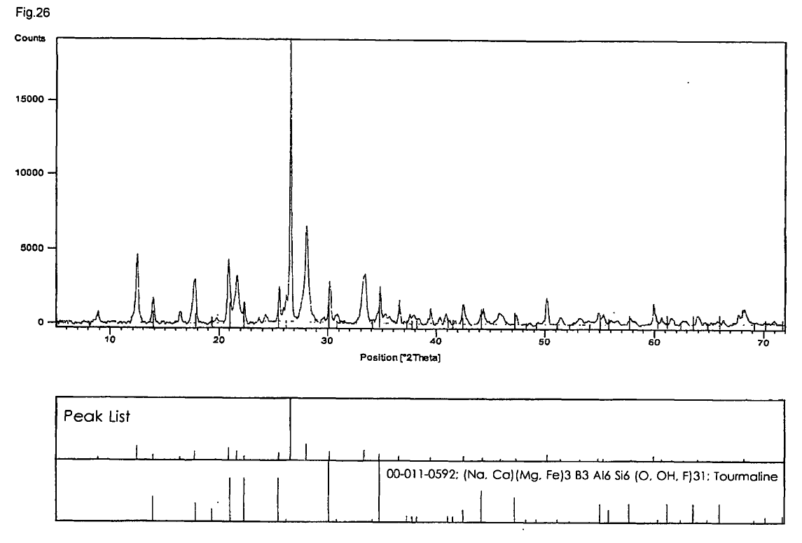

FIG. 26 shows a result of analysis of X-ray diffraction data of FIG. 25 focusing on tourmaline. From this result, there is a possibility that the ceramic material of the present invention further contains tourmaline. Note that, the ICCD data of tourmaline is no longer used as it is unreliable. In cases where the material contains tourmaline, based on the consistency with the result of X-ray fluorescence spectrometry, tourmaline is indicated by CaFe₃Al₆(BO₃)₃Si₆O₁₈(OH)₄.

In addition, the ceramic material of the present invention may contain other constituents in addition to the above crystals. The other constituents may exist not only in crystal form but also in non-crystal form such as in an amorphous form. In this case, since the constituent is not identified by X-ray diffraction, the ceramic material of the present invention will be identified by contained elements.

In addition, the ceramic material of the first embodiment, contains silicon, aluminum, iron, calcium, titanium, and potassium, as major constituents. These elements are constituents for identifying crystal structure of the ceramic material. These elements may exist as a simple element, or as a compound with the other elements.

In addition, the ceramic material of the first embodiment may contain sulfur, strontium, vanadium, and yttrium as accessory constituents. These elements are not constituents for identifying the crystal structure of the ceramic material, but addition of small amounts of them to the crystal change the properties of the substance. Hence, in many cases, the element as an accessory constituent exists not in a simple form but in a form of partial substitution of the other crystals.

It is preferable that the ceramic material of the present invention contains 40 to 50 wt % silicon; 25 to 35 wt % aluminum; 5 to 15 wt % iron; 5 to 10 wt % calcium; 1 to 5 wt % titanium and potassium; and 0.01 to 1 wt % sulfur, strontium, vanadium, and yttrium. The reason for this constituent ratio is that the ceramic material, which is included in the scope of the above constituent ratio, showed the desired effects in experiments.

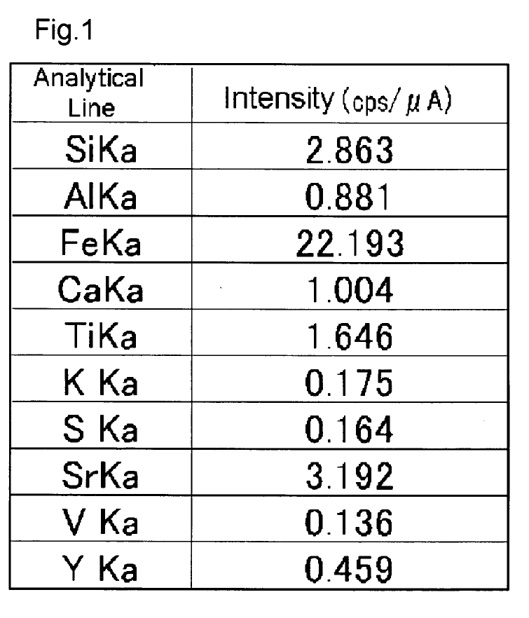

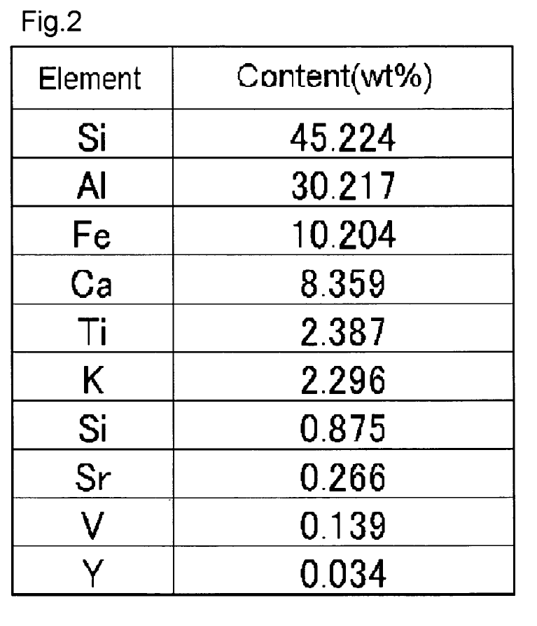

FIG. 1 shows a result of X-ray fluorescence spectrometry on the ceramic material of the first embodiment. The sample used for the measurement was formed into a disk shape by using starch for pretreatment. The scope of measured elements is from sodium (atomic number 11) to uranium (atomic number 92). FIG. 2 shows a result of analysis of elemental content from a result of X-ray fluorescence spectrometry. Note that, the ceramic material used in the measurement is one mode of the first embodiment, and if manufacturing condition differ, the ratio of constituent element slightly fluctuates. From this result, the elemental Na, which was detected in the X-ray diffraction analysis, is not detected. It is considered that the low detection sensitivity of the X-ray fluorescence spectrometry caused this result.

Examples of products using the ceramic material of the present invention include, an eye mask, an electromagnetic wave blocking sheet for a mobile phone, building material, a car body, parts of an electronic device, and metal material such as a frame, other than a cloth, an accessory, a cosmetic product, and a filter for liquid, described hereinbelow.

In order to obtain the ceramic material of the present invention, various manufacturing methods exist. One example thereof will be described hereinbelow.

40 to 45% Si, 25 to 30% Al, 8 to 10% Fe, 8.4% Ca, 2.4% Ti, 2.3% K, 0.88% S, 0.27% Sr, 0.14% V, and 0.03% Y are prepared. On this occasion, unavoidable incorporation of impurities is allowable. Subsequently, in a closed container, gradual heating and dissolution are carried out. On this occasion, substance composition in the container is determined so as to avoid transpiration of substances having a low melting point. Moreover, at least more than one of B (boron), Li (lithium), C (carbon), O (oxygen), or N (nitrogen) may be contained. It is preferable that ratios of these substances are 1 to 4% boron, 1 to 2% lithium, 0.1 to 4% carbon, 2 to 5% oxygen, and 0.1 to 4% nitrogen.

In addition, the suitable temperature for heating and dissolution is between 700 and 1200° C. Moreover, in cases where these materials are of composite materials, it is preferable that the materials are ground into ceramic granule having a diameter of 1 to 5 μm, and heated and dissolved at the above-mentioned weight ratios. For example, crystal material, in which Al and borosilicate are mixed, may be used.

In order to investigate the effects of the ceramic material of the present invention, the following experiments were carried out. In each experiment, three types of ceramic materials; A, B, and C, were used. A, B, and C were ceramic materials, respectively, manufactured using different materials and different manufacturing methods. Based on the results of quantitative analysis of the contained elements of the ceramic materials, by X-ray fluorescence spectrometry, it has been cleared that respective ceramic materials contain 40 to 50 wt % silicon; 25 to 35 wt % aluminum; 5 to 15 wt % iron; 5 to 10 wt % calcium; 1 to 5 wt % titanium and potassium; and 0.01 to 1 wt % sulfur, strontium, vanadium, and yttrium.

In order to study the biological effect of the ceramic material of the present invention, the effect of infrared radiation measurement on the material was carried out. Table 1 shows the experimental result of radiation rates for black-bodies of respective samples. The measured infrared wave lengths of respective samples were 8 to 14 μm.

TABLE 1
Experimental result of radiation rates
for black-bodies of respective samples

| Sample | A | B | C |
|---|---|---|---|
| Radiation rate | 0.902 | 0.863 | 0.916 |

From this Table 1, it is clear that the infrared wave lengths of respective samples were more than 0.8 μm, providing sufficient infrared radiation effects.

Next, scavenging properties of the ceramic material of the present invention for hydroxy radical (OH⁻) and superoxide radical (O₂⁻) was measured.

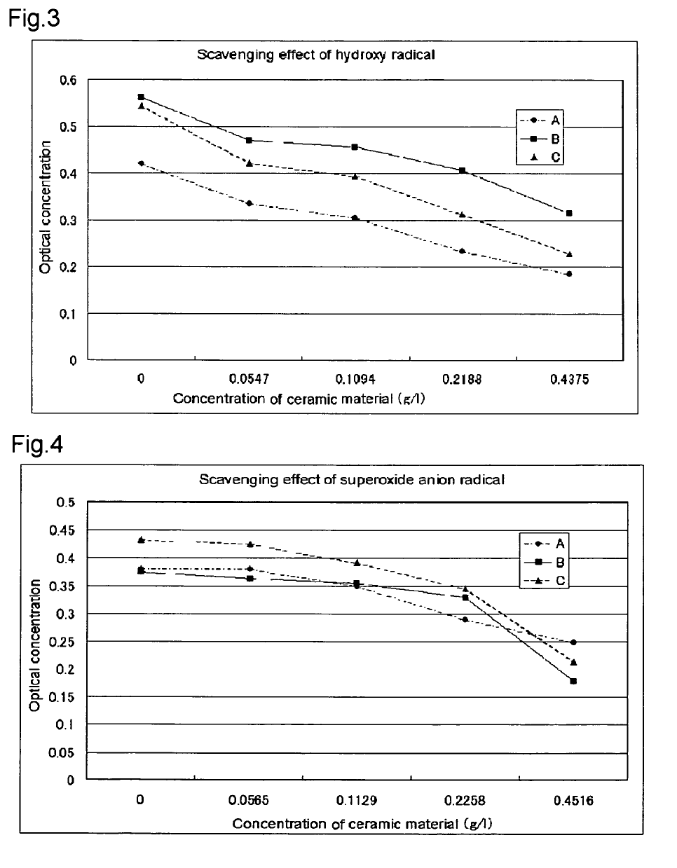

In order to disperse the ceramic material in liquid, the ceramic material was dissolved in 0.2% CMC (Sodium carboxy Methyl Cellulose), and suspensions having different concentrations were prepared. Next, a pink liquid was prepared by using the deoxyribose method. As the concentration of hydroxy radical in liquid increases, transparency of the liquid decreases, so that it becomes possible to estimate the change in concentration of the hydroxy radical by measuring optical concentration. FIG. 3 shows the measurement results of the optical concentration when the concentrations of the ceramic materials A to C were changed. In addition, as to the concentration of superoxide anion radical, similar to the above, the optical concentration thereof was measured by xanthine oxidase method (FIG. 4).

From the above experimental results, it became clear that as concentration of the ceramic material in liquid increases, the optical concentration decreases. It is inferable that the ceramic material in the liquid reduces hydroxy radical (OH⁻) and superoxide radical (O₂⁻), so that the optical concentration was reduced. Hence, it became clear that the ceramic material of the first embodiment is able to scavenge hydroxy radical (OH⁻) and superoxide radical (O₂⁻), which are free-radicals.

In addition, an effect on electric conductivity of water by the ceramic material of the first embodiment was studied. 2 mg of ceramic material was mixed into 5 ml of tap water and left for 15 minutes, after that, supernatant liquid thereof was filtered with a millipore filter (filter bore, 0.22 μm). After that, the conductivity of the tap water mixed with the ceramic material and the conductivity of the filtered water were measured.

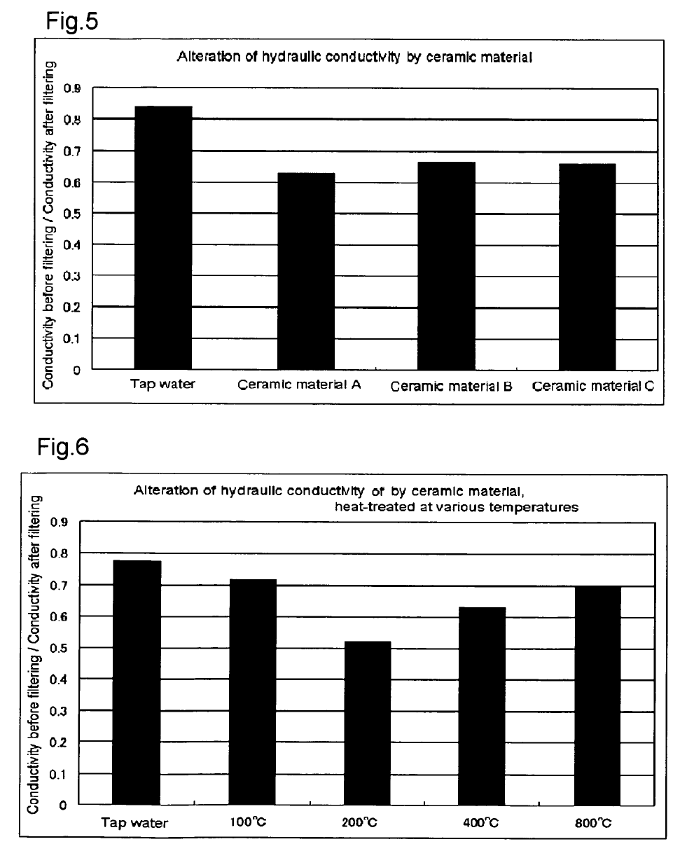

Further, in view of the effects of the millipore filtration on the conductivity of water, the conductivity of the tap water, not containing the ceramic material, before and after millipore filtering, were respectively measured, FIG. 5 shows electric conductivity after filtration and before filtration. As for the ceramic materials A and C, the electric conductivities thereof were definitely reduced compared with those of the tap water, so that it became clear that the ceramic material of the first embodiment reduces electric conductivity of water.

In addition, FIG. 6 shows the effects on hydraulic conductivity of tap water by the ceramic material, heat-treated at various temperatures, in which the effects were measured by the same manner as that of FIG. 5. Based on the result, it became clear that the ceramic material heat-treated at 200° C. has the strongest effect of reducing hydraulic conductivity. Hence, from the above results, the ceramic material of the first embodiment has the effect of reducing hydraulic conductivity.

Examples of ions contained in water include calcium ion and magnesium ion. If these ions are rich in water, lathering of soap becomes poor, thereby reducing detergency. Further, drinking the water containing these ions causes gastrointestinal disease leading to diarrhea. By purifying water using the ceramic material of the first embodiment, it becomes possible to prevent the above deficiencies.

In order to determine if the ceramic material of the first embodiment is safe for a living organism, acute toxicity tests for animal were carried out.

An experimental animal, Kuming mouse (♂, 20±2 Kg) was used. A solution, in which a mixture of the ceramic material and 0.2% carboxy methylcellulose was ground and suspended, was prepared. This solution was injected directly into the stomach of the mouse, and observation of the death rate of the mouse was carried out for a week. Table 2 shows the death rate of the mouse by dosage (g/kg) of the ceramic material. As a result, death caused by dosage of the ceramic material was not observed. Hence, it became clear that the toxicity of the ceramic material of the first embodiment for a living organism is quite small and the ceramic material of the first embodiment is safe.

TABLE 2
Death rate of the mouse by dosage (g/kg) of the ceramic material

| Dosage (g/kg) | Death rate |
|---|---|
| 0.46 | 0 |
| 0.92 | 0 |
| 1.38 | 0 |
| 1.84 | 0 |
| 2.30 | 0 |
| 2.76 | 0 |
| 3.45 | 0 |
| 4.31 | 0 |
| 5.40 | 0 |
| 6.74 | 0 |

The second embodiment relates to ceramic powder, which is manufactured by grinding the ceramic material of the embodiment.

The ceramic powder of the second embodiment can be separated into large-grain ceramic powder and small-grain ceramic powder. There is a manufacturing method for ceramic powder, for example, by grinding the ceramic material of the first embodiment using a vibrating mill.

The vibrating mill mixes the ceramic material and a grinding medium, whose shape is spherical or columnar etc. (Hereinafter, referred to as a grinding ball), in a grinding cylinder, and vibrates them (at an appropriate amplitude and frequency), thereby grinding them by using force of impact between the ceramic material and the grinding ball. After that, obtained powder is separated by a filter having a predetermined filter bore, so that only the powder having desired grain size is obtained. Further, according to the difference of sinking velocity in the water, it becomes possible to separate the powder by grain size.

The large-grain ceramic powder contains more than 90 wt % ceramic granules, wherein the ceramic material according to the first embodiment is made into the ceramic granule having a diameter of 1 to 5 μm. The large-grain ceramic powder is mainly used for a filter for liquid.

The small-grain ceramic powder contains more than 90 wt % ceramic granules, wherein the ceramic material according to the first embodiment is made into the ceramic granule having a diameter of 10 to 100 nm. The small-grain ceramic powder is mainly used for a cosmetic product.

The ceramic powder of the second embodiment has a large surface area, making it reactive to other substances. Therefore, among properties of the first embodiment, the properties of free-radical scavenging and of reducing hydraulic conductivity are pronounced.

The third embodiment relates to products using the ceramic material or the ceramic powder of the above embodiments.

The cloth and accessory of the third embodiment use the ceramic material of the first embodiment as raw material. Moreover, the filter for liquid of the third embodiment uses the ceramic powder of the first embodiment. Furthermore, the cosmetic product of the third embodiment use the small-grain ceramic powder of the first embodiment.

The cloth of the third embodiment can be obtained by spraying the ceramic material of the first embodiment to a nonwoven. Examples of application of cloth of the third embodiment include a bed pad and an electromagnetic wave blocking sheet for a mobile.

Examples of the accessory of the third embodiment include a bracelet, a necklace, a ring, and a watch. These accessories have direct contact with a body, so that it becomes easy to produce the effects of the first embodiment.

These accessories are manufactured, for example, by mixing the ceramic material of the embodiment into melted metal as a material, and by processing the solidified material to an accessory. Further, after processing the metal as a material of an accessory, the ceramic material of the embodiment may be embedded and bonded thereto.

The infrared radiation effect of the cloth (nonwoven) of the third embodiment was measured. Table 3 shows the infrared radiation rate of the nonwoven using the ceramic material of the embodiment (the nonwoven 1), and of the nonwoven not using the ceramic material of the embodiment (the nonwoven 2). The measurement was carried out by using wave length of the infrared radiation was 8 to 14 μm. As a result, it became clear that a high infrared radiation rate was indicated, when spraying the ceramic material to the nonwoven.

TABLE 3
Infrared radiation rate of the nonwoven using the ceramic material
of the embodiment (Nonwoven 1), and of the nonwoven not using
the ceramic material of the embodiment (Nonwoven 2)

| Sample | Nonwoven 1 | Nonwoven 2 |
|---|---|---|
| Radiatoin rate | 0.865 | 0.505 |

As to blood rheological index, the effects on groups (bracelet group, necklace group, ring group, watch group, and bed pad group) were studied. The subjects were grouped by age, the younger subjects group, consisted of six men and six women aged 18 to 25, and the middle-aged and older subjects group, consisted of 8 men and 12 women aged 45 to 60. Many subjects of the middle-aged and older subjects group had different diseases such as high blood pressure, hyperlipemia, tumors, cardiac infarction, and diabetes mellitus. At the outset, blood samples were taken from the subjects. After that, the above products were provided. Four months later, blood samples were again taken from the subjects under the same conditions and time. The treatment plans for the previous diseases of the subjects remained the same, and dosages of drugs were continued and no other drugs were taken, so that only the products used upon measurement could make effects.

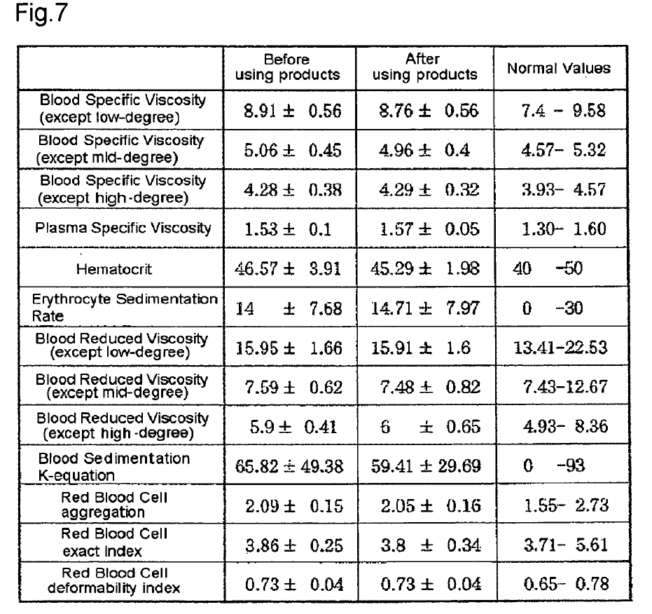

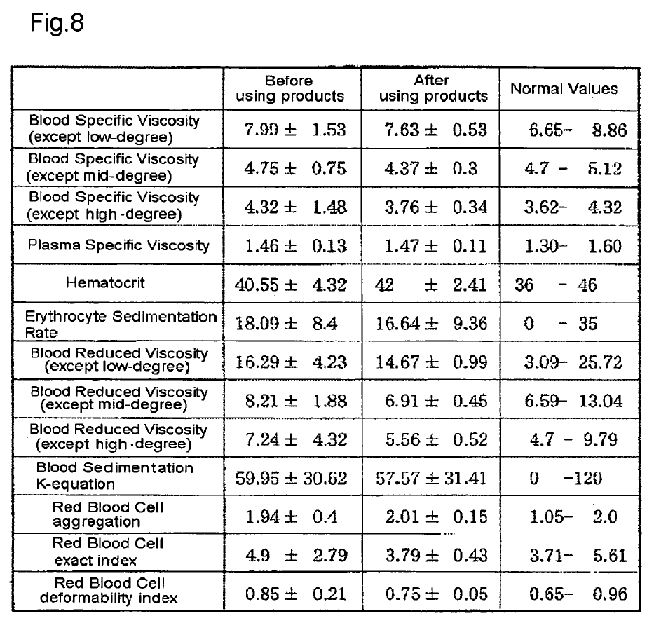

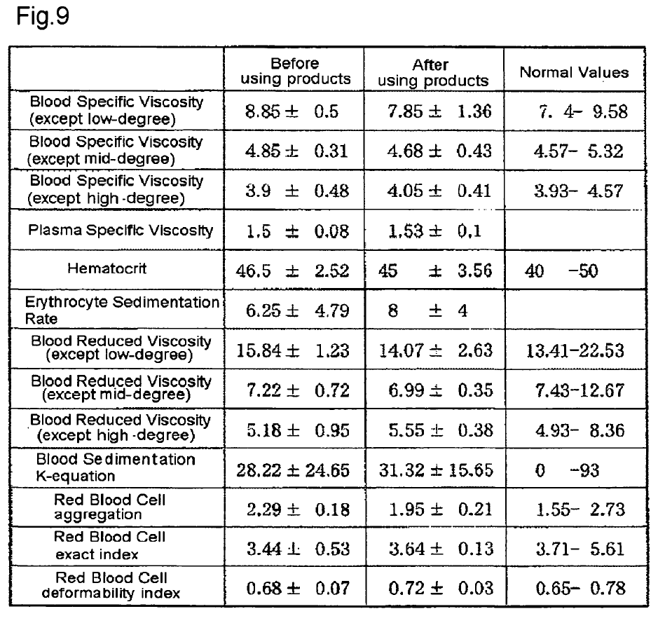

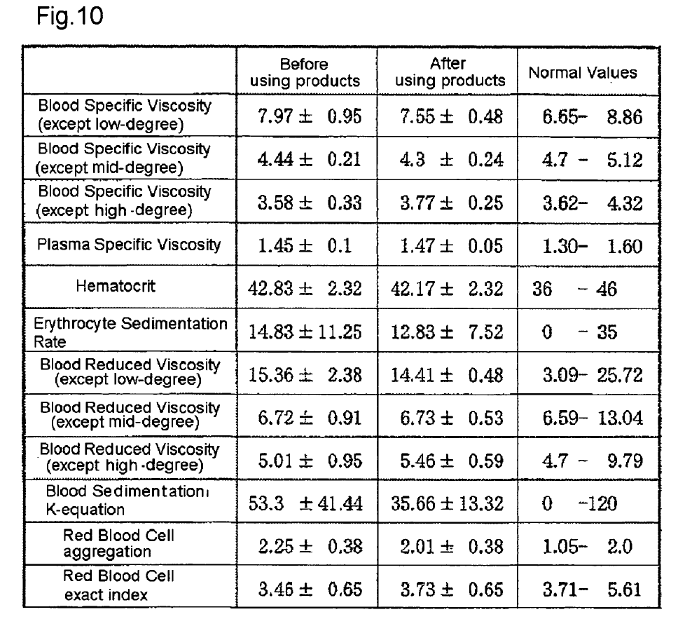

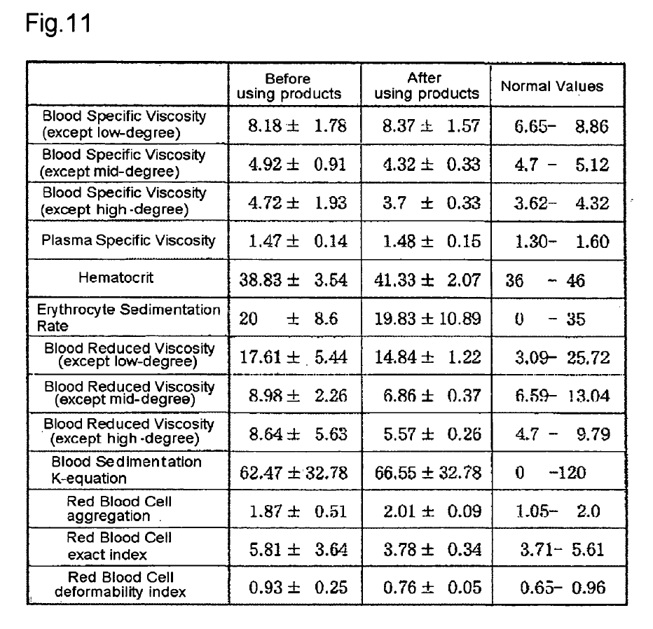

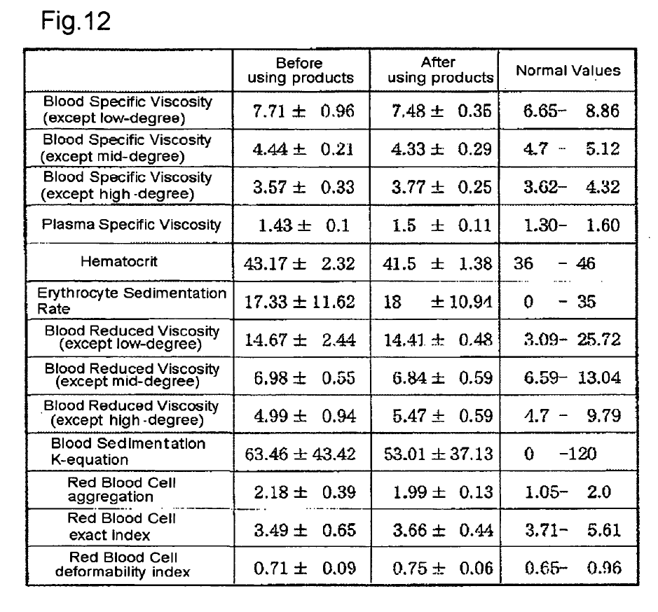

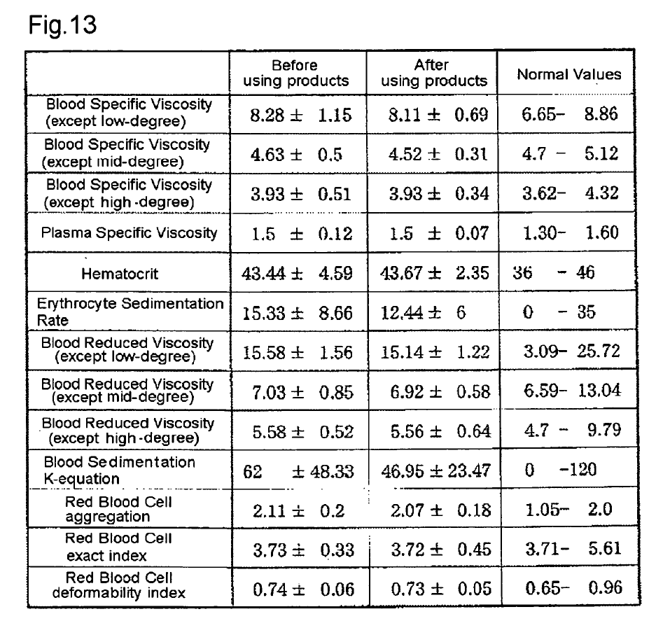

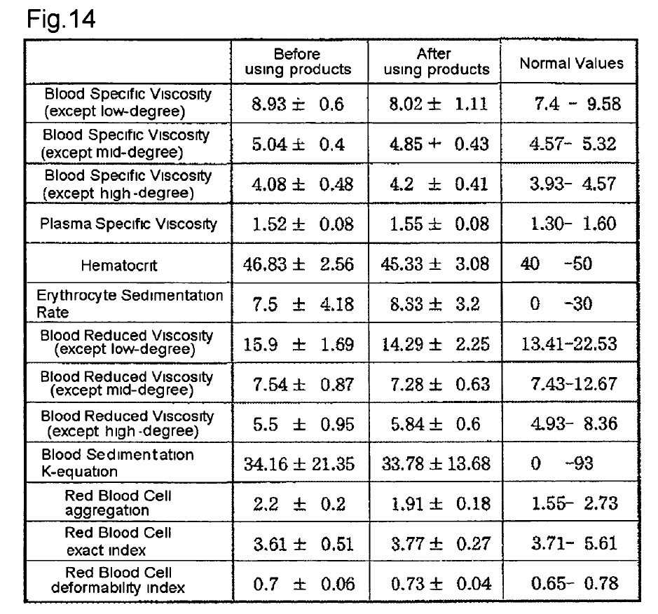

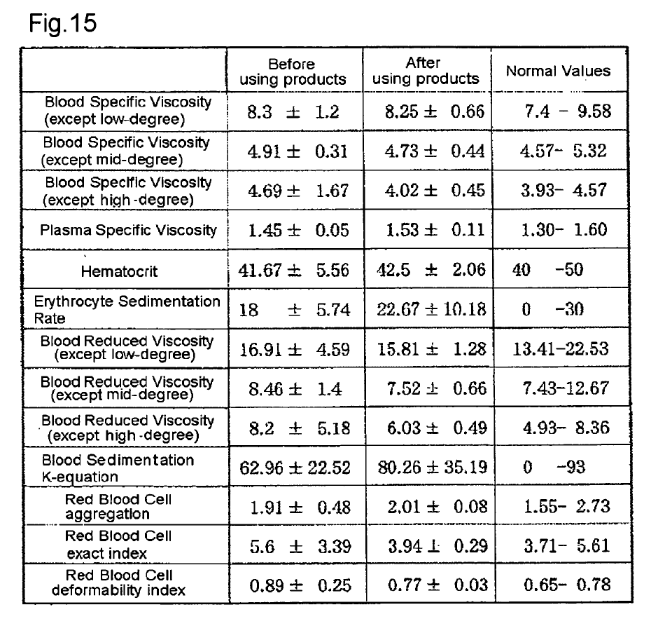

FIG. 7 to 15 show the blood rheological indexes before and after using the products. From these results, it became clear that by using the products of the third embodiment, reduction of blood viscosity (high resistance to blood flow) was observed in most groups. Hence, by using the products of the third embodiment such as the bracelet, necklace, ring, watch or bed pad, blood circulation was improved.

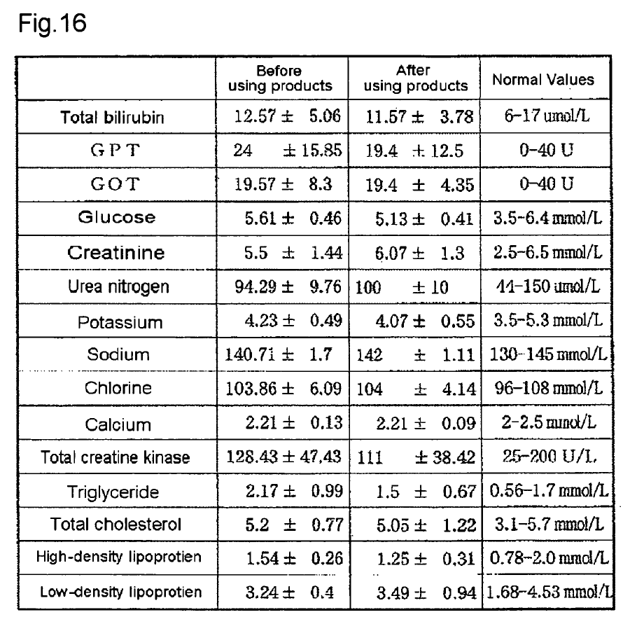

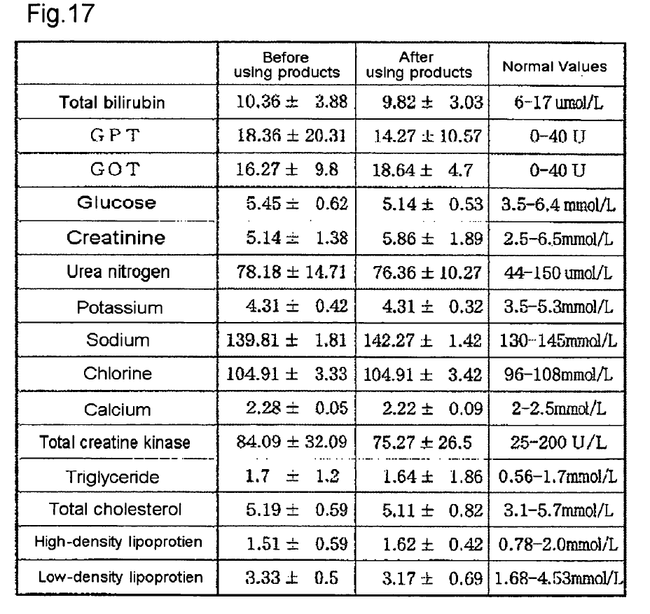

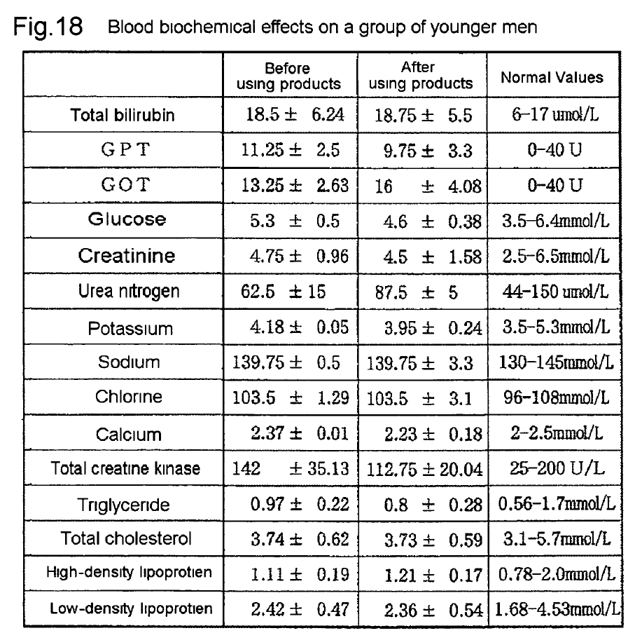

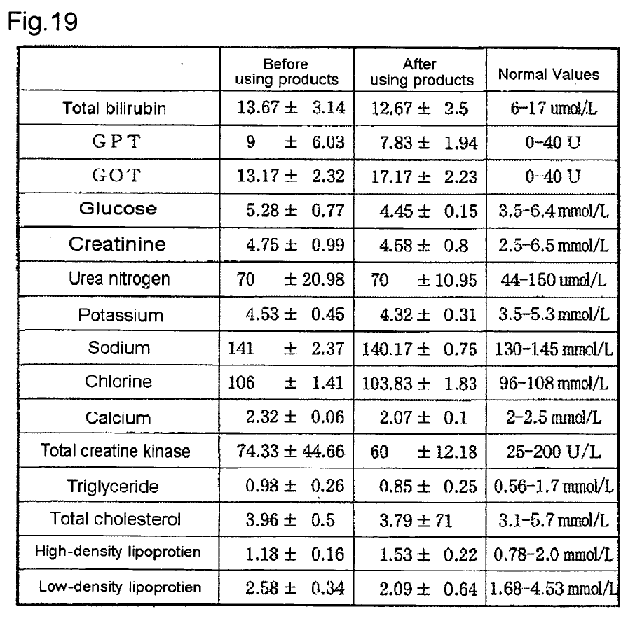

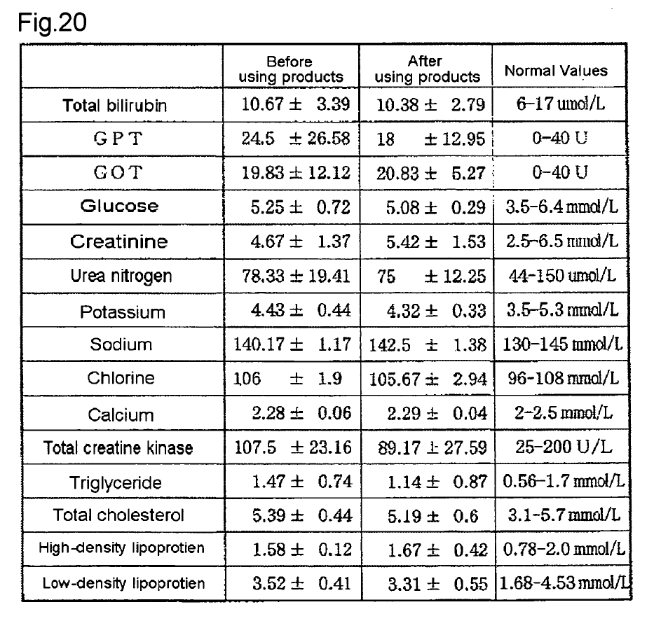

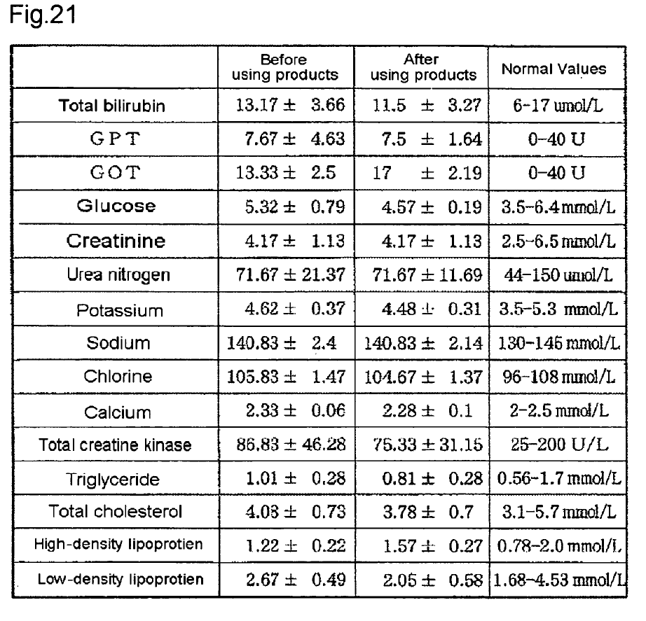

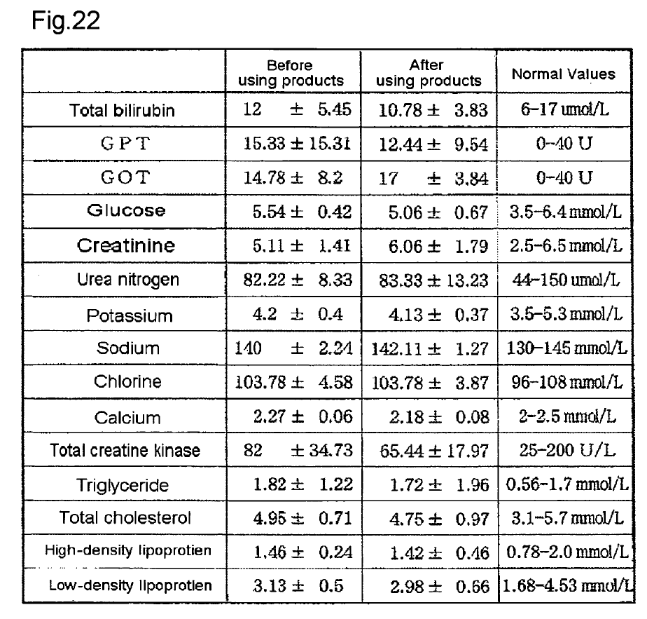

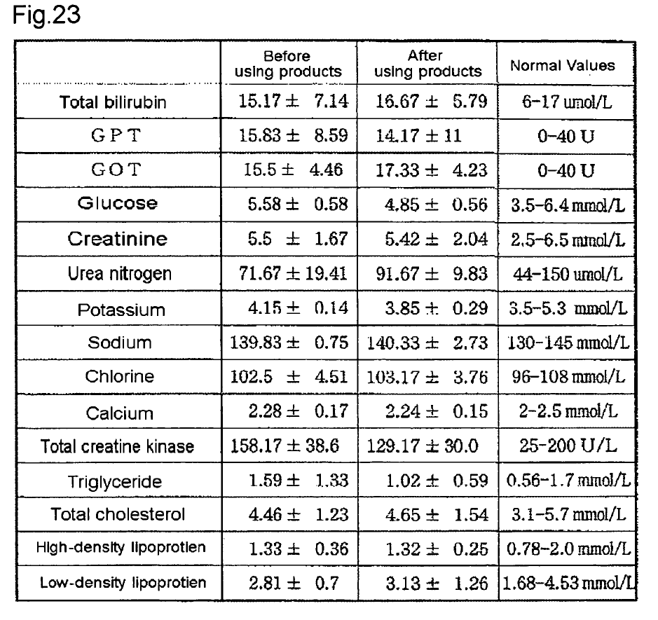

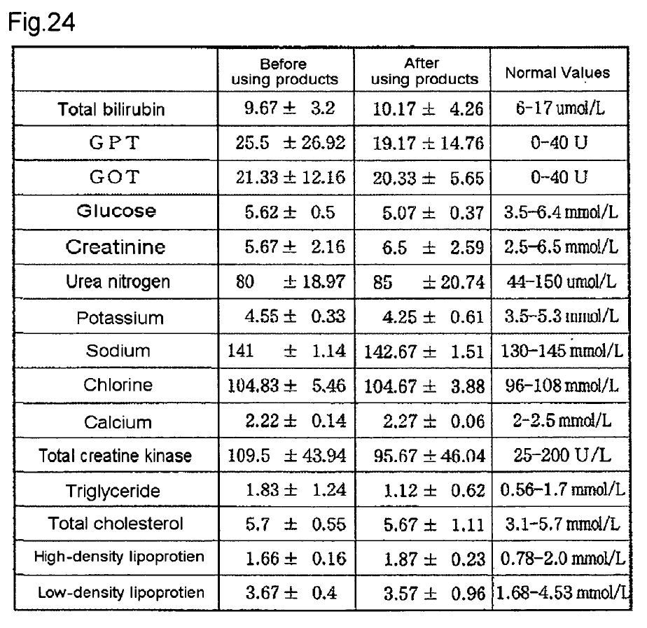

As for the blood biochemical index, the effects on groups (bracelet group, necklace group, ring group, watch group, and bed pad group) were studied. The subjects and the experimental method are the same as in the case of the blood rheological index. FIG. 16 to 24 show the blood biochemical indexes before and after using the products. In these drawings, GPT is glutamic-pyruvic transaminase, and GOT is glutamic-oxaloacetic transaminase.

From the above results, it became clear that: (1) In all groups, GPT indicating hepatic function, and values of creatine kinase, related to the heart, were lowered. (2) Except the younger men's group and the group of people wearing watches, in the case of most subjects, the total cholesterol level, relating to hyperlipemia, were lowered. (3) In all groups, the glucose levels relating to diabetes mellitus were lowered. From the above results, it became clear that the products of the third embodiment such as a bracelet, a necklace, a ring, a watch, and a bed pad improved heart function and hepatic function to a certain level, and thereby effective in improving hyperlipemia and diabetes mellitus.

1. A ceramic material, containing four crystals respectively indicated by SiO₂, Na₆Al₆Si₁₀O₃₂.12H₂O, KCa(Si₅Al₃)O₁₆.6H₂O, and KAl₂Si₃AlO₁₀(OH)₂.

2. The ceramic material according to claim 1, further containing tourmaline.

3. The ceramic material according to claim 2, wherein the tourmaline is indicated by CaFe₃Al₆(BO₃)₃Si₆O₁₈(OH)₄.

4. A ceramic material, containing silicon, aluminum, iron, calcium, titanium, and potassium as major constituents.

5. The ceramic material according to claim 4, further containing sulfur, strontium, vanadium, and yttrium as accessory constituents.

6. The ceramic material according to claim 5, containing 40 to 50 wt % silicon; 25 to 35 wt % aluminum; 5 to 15 wt % iron; 5 to 10 wt % calcium; 1 to 5 wt % titanium and potassium; and 0.01 to 1 wt % sulfur, strontium, vanadium, and yttrium.

7. The ceramic material according to claim 4, containing at least more than one of boron, lithium, carbon, oxygen, or nitrogen.

8. The ceramic material according to claim 4, containing 1 to 4% boron, 1 to 2% lithium, 0.1 to 4% carbon, 2 to 5% oxygen, and 0.1 to 4% nitrogen.

9. The ceramic powder containing more than 90 wt % ceramic granules, wherein the ceramic material according to claim 1 is made into the ceramic granule having a diameter of 1 to 5 μm.

10. The ceramic powder containing more than 90 wt % ceramic granules, wherein the ceramic material according to claim 1 is made into the ceramic granules having a diameter of 10 to 100 nm.

11. A cloth, wherein the ceramic material according to claim 1 is used as a raw material.

12. An accessory, wherein the ceramic material according to claim 1 is used as a raw material.

13. A cosmetic product, wherein the ceramic powder according to claim 10 is used.

14. A filter for liquid, wherein the ceramic powder according to claim 9 is used.

15. A filter for liquid, wherein the ceramic powder according to claim 10 is used.
